(19) United States
(12) Patent Application Publication
(10) Pub. No.: US 2023/0267517 A1
(43) Pub. Date: Aug. 24, 2023

(54) Integrated Systems And Methods For Contract Process Management

(71) Applicant: ADEMOLA SOLARU, Beachwood, OH (US)

(72) Inventor: ADEMOLA SOLARU, Beachwood, OH (US)

(21) Appl. No.: 17/676,770

(22) Filed: Feb. 21, 2022

(51) Int. Cl. G06Q 10/06; G06Q 10/08

(52) U.S. Cl. CPC G06Q 10/06315; G06Q 10/063114; G06Q 10/087

(57) ABSTRACT

Systems and methods for the management of contract-related processes are provided on a centralized user-accessible interface provided by one or more computer devices that can be configured to record, monitor, authorize, submit, accept, track and analyze the provision of and/or payment for contracted goods and services and related expenditures, and transfer payment details to accounting and payment systems. The systems and methods can use a single system with functions, features and capabilites that are integrated with one another with inputs and outputs made across the system in real time. Some or all of the systems and methods can be made available to be used by contract administrators and contractors.

### FIELD OF THE INVENTION

The invention relates to integrated systems and processes for some or all aspects of managing contractual (and other agreement) relationships, rights, obligations, duties, performance, terms, billing/invoicing and/or expenses.

### BACKGROUND OF THE INVENTION

The management of parties and their rights and obligations operating under an agreement, such as a contract, grant, and other types of transactions, can often be complex and it is often done by impromptu methods and by different people and different departments in organizations, including companies, entrepreneurs, governments, and other entities. Such management often fails to apply the terms of the different agreements being managed transparently, correctly, consistently, timely and efficiently, in a manner that benefits one or both of the parties. This is especially the case with changes in personnel, limitations in the hiring of employees, and management of an agreement that is complex, and/or that crosses different departments' and/or personnel duties and responsibilities, especially if the agreement is in operation for an extended period of time.

Contracts and associated billings are often managed manually, and in separate domains of an organization (e.g., Contract Administration versus Billing Departments). Even with computerization and digitization, these two domains are still treated as separate in invoicing systems and contract management systems. Current methods also often provide low responsiveness to increasingly dynamic contract-based transactions. Attempts at organization and management often involve the digitization of the terms of transactions, which often simply translates paper invoices to digital format without addressing the need to keep fund sources and limits, contract details, and support document and payment systems in sync on a timely and accurate basis. The systems and methods used in the past often were used by separate people in separate departments and were not, and could not be, integrated to one another. Even a single person attempting to perform a few of the functions would need to access several different systems (e.g., accounting systems, word processing systems, databases) to accomplish simple tasks.

These multiple system, siloed, processes were not synchronized and could not provide the ability to make synchronized, real time inputs across all of them. They also could not be used to obtain accurate, real time outputs across all of them. New and improved methods for the integrated management of these agreements are needed to achieve greater efficiency and accuracy in contract process management.

### SUMMARY OF THE INVENTION

This invention concerns an integrated system for contract billing and expense management for any size organization (e.g., companies, entrepreneurs, government agencies, charities, and other organizations). This invention can be applied to enable such organizations to stay on top of the details of their provided and received contractual services and enable monitoring of such goods and services as they are delivered and reported by the organization's network of parties to their agreements, while providing a clear breakdown of expenditures tied to the contractual terms. In some of the embodiments of this invention, some or all of these functions (e.g., features, functions, capabilities) can be done for the first time in real time to provide timely and accurate information to accountants, reviewers, planners, management, and/or others.

It is an object of this invention to provide integrated systems and methods for contract process management that can manage many to all of the aspects of multiple contracts in real time;

It is another object of this invention to provide integrated systems and methods for contract process management that can manage many to all of the relevant details of multiple contracts in real time;

It is another object of this invention to provide integrated systems and methods for contract process management that can check the accuracy of inputs and outputs in real time;

It is another object of this invention to provide integrated systems and methods for contract process management that can automate creation of audit trails in real time in each transaction and update;

It is another object of this invention to provide integrated systems and methods for contract process management that can eliminate the additional effort needed to classify expenses in different ways for different applications (such as service categories, organizational goals, programs, and subcomponents), which required significant analysis to tease out of billing and/or other data;

It is another object of this invention to provide integrated systems and methods for contract process management that can answer the questions of where funds are allocated, where funds are spent, which contractor or specific services are the funds spent with in real time;

It is another object of this invention to provide integrated systems and methods for contract process management that can support cashflow forecasting by providing real time information as to unbilled services and the rate of expenditure as compared to an expected time-frame;

It is another object of this invention to provide integrated systems and methods for contract process management wherein the interfacing is not done in time-delayed batch updates or manual updates by multiple users updating different systems at different times;

It is another object of this invention to provide integrated systems and methods for contract process management wherein the relationships between the contract, the related funds, the billings, the support documentation, and the administrative approvals all work synchronously and in real time;

It is another object of this invention to provide integrated systems and methods for contract process management wherein all of the functions, features and/or capabilities are synchronized in real time.

These and other objects are provided by embodiments of this invention.

A significant component of contract management is to assure compliance with legal and financial terms of executed contracts. Certain preferred embodiments of this invention are concerned with ensuring that payment is according to the agreed terms of the contracts, and that services are accounted for in detail, reflecting the rates, schedules, and service applications of each of the contracts.

Certain preferred embodiments of this invention manage billing components of contract administration. These preferred embodiments ensure that each contracted deliverable is controlled and accounted for, at levels of detail determined by the contracting entity.

Contract monitoring is necessary for several types of contracts (and portions of contracts), including Financial Agreements, Long Term Contracts, Short Term Contracts, Grants, Memoranda of Understanding (MOU) and other agreements. Certain preferred embodiments address each of the specific requirements of some or all of these types of contracts. The term “contract” and “agreement” are used in their broadest sense to include any type of agreement or mutual understanding between parties.

Certain preferred embodiments of this invention manage the flow of claimed expenses from one or more contractors to one or more contracting entities. These preferred embodiments serve as the monitoring middleware ensuring that all contract funds are accurately accounted for, tracking individual funds used by contracted services, and mapping expenditures to intended programs, corporate goals, assets, and persons in the appropriate service categories. In especially preferred embodiments, these features are provided for by Fund Manager and Tracking Designations modules of this invention. These modules can interact with each other and other modules of this invention, and be accessed by a user interface.

Certain preferred embodiments of this invention enforce contract schedule control over contractor billings, manage multiple contracts and contractors efficiently, resulting in accurate and faster payment turnaround. These preferred embodiments also support both payer (payables) and payee (receivables) functions in the same unified interface. The interface in certain embodiments allows a user to track what they will pay, or, in some embodiments, get paid. In especially preferred embodiments, these features are provided for by Contract Receivables (Billing and Documentation) and Contract Payables (Reviews and Approvals) modules of this invention. These modules can interact with each other and other modules of this invention, and be accessed by a user interface.

After an agreement is executed, certain preferred embodiments of this invention can be applied to manage the contractual obligations and duties of the parties. The user may, for example, apply these embodiments to assume either a payer or payee role. In especially preferred embodiments, these features are provided for by Contract Detail and Authorization Management modules of this invention. These modules can interact with other modules of this invention, and be accessed by a user interface.

Additional modules in certain preferred embodiments include modules for an Accounting Interface (Payment Integration) and Analytics. These modules can interact with other modules of this invention, and be accessed by a user interface.

If a payer (e.g., contract, agreement, or grant originator in some instances) role is chosen, these embodiments such as the specific modules described above can be configured to provide the user management to enforce the contract, agreement, or grant limits; track fund sources and usage; track program, services, and goals; control approvals; and manage the contractor network.

If a payee (e.g., contractor in some instances) role is chosen, these embodiments such as the specific modules described above can be configured to provide the user tools to submit documents to support charges; track progress of submitted bills; track progress of approvals in real time; submit corrections; and by doing so, enhance their opportunities to get paid faster and more efficiently.

Certain preferred embodiments of this invention provide the user with a process that is a seamless flow from fund sources to payments, and at each step, tracking controls assure efficiency, timeliness, and accurate reporting. Everyone involved with the contract, agreement or grant when using these embodiments is always on the same page. The interface to the system is how users adapt to the administrator's financial environment. These tools include (but are not limited to) fund management, tracking designations, contract details and monitoring, contract receivables, contract payables, authorization management and approvals, and payments (e.g., accounting interface with payment integration, and analytics), examples of which are provided below. These tools can be provided in one or more modules that interact with one another and provide an interface accessible to one or more users.

Fund Management: certain preferred embodiments of this invention provide accounting of available funds in accounts. These features can be provided in one or more modules of this invention.

Tracking Designations: certain preferred embodiments of this invention track funding sources, goals, programs, persons, assets, and service categories. These features can be provided in one or more modules of this invention.

Contract Details and Monitoring: certain preferred embodiments of this invention provide contract balances and terms, service line items, service deliverables and payment milestones. These features can be provided in one or more modules of this invention.

Contract Receivables: certain preferred embodiments of this invention provide charges, invoices, and service documentation. These features can be provided in one or more modules of this invention.

Contract Payables: certain preferred embodiments of this invention provide accounting and record keeping of reviews and approvals concerning contractor billings. These features can be provided in one or more modules of this invention.

Authorization Management and Approvals: certain preferred embodiments of this invention provide pre-authorized services, invoice reviews, and payment approval. These features can be provided in one or more modules of this invention.

Accounting Interface/Payments and/or Analytics: certain preferred embodiments of this invention provide a journal/payment/accounting system interface with payment integration, and/or analytics. These features can be provided in one or more modules of this invention.

Certain embodiments of this invention provide multiple options to maintain full control over the rate of contracted service expenditures. Using pre-authorization capabilities, these embodiments also help ensure that expenditures are aligned with independently negotiated service limits and other contractual terms, ensuring compliance when contractor invoices and service documentation are submitted for payment.

Certain embodiments of this invention simplify and streamline the process for receiving invoices from contractors. Contractors can only submit charges against services and specific deliverables that are authorized in their contracts at particular points in the contract life cycle. Expenditure ceilings are continually enforced against fund and contract limits, ensuring no overruns against established budgets.

Certain embodiments of this invention provide a broad spectrum of operational analytics to assure easy, on-demand tracking of contract details. Using dashboards and easily queried reporting features, these embodiments provide easy monitoring of the general ledger fund sources, as well as the details of contractor service classifications for each delivered service.

For contractor settlement, embodiments of this invention enable the easy transfer of accounting details to a payment system for even more streamlined processing, i.e., the electronic transfer of approved billing details to an accounting system.

A particularly preferred embodiment of this invention comprises five core functions that (1) manage an entity's contracts in detail; (2) manage the authorization of services; (3) submit and track invoices against contract limits; (4) analyze/monitor contract progress; and (5) integrate accounting and payment systems.

(1) Monitoring/Management Of Contracts In Detail. This preferred embodiment enables a contracting entrepreneur, organization, or government entity to stay on top of all details of contracted services. It enables easy monitoring of services as they are delivered and reported by your contractor network and provides a clear breakdown of expenditures tied to contract terms. These features can be provided in one or more modules of this invention (e.g., Fund Manager, Tracking Designations, and/or Contract Detail modules).

(2) Management Of Authorization Of Services. This preferred embodiment provides multiple options to maintain full control over the rate of contracted service expenditures. Using pre-authorization capabilities, it helps you ensure that expenditures are aligned with pre-negotiated expectations, so there are no surprises when contractor invoices and service documentation are received. These features can be provided in one or more modules of this invention (e.g., Authorization Management module).

(3) Submit And Track Invoices Against Contract Limits. This preferred embodiment simplifies and streamlines the process for receiving invoices from contractors. Contractors can only submit charges against services and specific deliverables in their contracts. Expenditure ceilings are continually enforced against fund and contract limits, ensuring no overruns against established budgets. These features can be provided in one or more modules of this invention (e.g., Contract Receivables and Contract Payables modules).

(4) Analyzing/Monitoring Of Contract Progress. This preferred embodiment provides a broad spectrum of operational analytics to assure easy, on-demand tracking of contract details. Using dashboards and easily queried reporting features, this preferred embodiment provides easy analysis, viewing and monitoring of funds sources, contractor services and expenditures for each contracted deliverable up-to-the-moment. These features can be provided in one or more modules of this invention (e.g., Analytics module).

(5) Integrating Accounting And Payment Systems. For contractor settlement, this preferred embodiment enables the easy transfer of accounting details to the user's payment system for even more streamlined processing. These features can be provided in one or more modules of this invention (e.g., Accounting Interface module).

As is described herein, the features and capabilities of this invention can be provided in one program and/or in sets of interacting and integrated modules. The number of actual modules can differ in each application, as modules can have different functions, features and capabilites that are contained in each one. Thus, for example, in one application, three modules may provide a given set of features and capabilites, while in another application, one module may provide the same set of features and capabilites.

Certain preferred embodiments of this invention are comprised of six interacting and integrated modules. These modules include modules with features and capabilites of (1) fund management, (2) contract processing, (3) service authorization, (4) contractor billing, (5) service documentation, and (6) management reporting. Synchronizing all aspects of transactions provides novel and non-obvious features and capabilities, such as the flagging of all services in the system (including notifications to providers) if a fund was modified or suspended for an already contracted service, or notifying a particular administrator whenever service documentation or invoices are submitted. Such notices are real time; heretofore, in the past there was limited transparency between the contract administration and the contractor domains, except in the limited case for billing approvals (or disputes) typically undertaken after the fact.

In the past, the siloed (i.e., multiple disconnected) systems worked asynchronously and were prone to errors and delays. For example, for the purpose of making corrections, adjustments, updates, etc., the siloed systems were not timely, accurate or efficient. In the siloed systems, interfacing is done with time-delayed batch updates (e.g., usually overnight, and not in real time) or manual updates done by multiple users updating different systems at different times. The preferred embodiments of this invention synchronize many to all of these functions, features, and capabilities. These embodiments provide effective management because the relationship between the contract, the related funds, the billings, the support documentation, and the administrative approvals all work synchronously and in real time.

The most preferred embodiments of this invention integrate the key aspects of contract processing, providing ultimate control over the flow of funds from the contracting organization to the contractor, including intermittent communications, and ensuring all activity is within prescribed limits. These embodiments eliminate the need for manual updates, contentious interfaces and seamlessly enforce the synchronicity required to ensure that a snapshot of any contract status at any given time is always up to the moment and accurate, and reflects the terms of contractual agreement.

Certain embodiments of this invention through their integrated features, provide significant leverage to each contract administrator to manage multiple contracts at the same time in significant detail, while assuring accuracy and efficient processing, and automatically creates an audit trail from every transaction and update. These embodiments eliminate the additional effort required in other systems to classify expenses in different ways (such as service categories, organizational goals, programs, and subcomponents) which required significant analysis to tease out of billing data: all these capabilities are anticipated and built into these embodiments. In one integrated system, these embodiments answer the questions easily—where funds are allocated, where spent, which contractor or specific services are they spent with—and even provide insights to the contract administrator for unbilled services and the rate of expenditure as compared to expected timeframes thereby supporting cashflow forecasting.

Advantages of usability provided by embodiments of this invention are to simplify and make harmonious the use of these modules that would allow a solo actor (e.g., entrepreneur) to use all features or multiple actors (e.g., a team or staff with separated duties in an organization) to use each of the modules without overlap or ambiguity as to who has access to which contracts or funds. The ability for that solo or team operation to onboard and manage multiple contracts and contractors in the shortest time possible is an important advantage: the user experience ensures that an initial use of an embodiment of this invention is quick while making it very apparent that it is multiple times more efficient than creating or starting up five or more separate systems. This is accomplished by the design of the main modules, with a culminating interface to existing payment systems (where final settlements are made) in the most efficient manner.

The advantages of certain embodiments of the system of this invention are that through its integrated features, it provides significant leverage to each contract administrator to manage multiple contracts at the same time in significant detail, while assuring accuracy and efficient processing, and automatically creates an audit trail from every transaction and update. It eliminates the additional effort required in other systems to classify expenses in different ways (such as service categories, organizational goals, programs, and subcomponents), which required significant analysis to tease out of billing data: all these capabilities are anticipated and built into these embodiments of this invention. In one integrated system, it answers the questions easily—where funds are allocated, where spent, which contractor or specific services are they spent with—and even provides insights to the contract administrator for unbilled services and the rate of expenditure as compared to expected timeframes thereby supporting cashflow forecasting.

This invention offers several additional benefits and advantages over previous methods that will be understood by a person of skill in the art. These include but are not limited to the benefits of certain preferred embodiments of this invention that require a small number of people (as few as just one) to manage a network of parties and their rights and obligations under the applicable agreements, including managing an organization's contractors, settings and managing the parameters that ensure that billings relate to control details of each contract. Certain embodiments of this invention accommodate a broad spectrum of contracts ranging from simple (requiring few details to track and control) to sophisticated (requiring a more intensive level of tracking such as milestone-phased, authorized services and multiple rates per deliverable). These embodiments make the commonality of Contracts and Billings to be managed all in one place, and synchronize the financial elements in real time. This is not possible with manual or separately managed systems, and is not otherwise provided in the marketplace today.

The processes and capabilities of the embodiments of this invention are performed by computer executable functions that are stored on a computer device (e.g., computer desktop, remote server) that run on a computer terminal, smartphone or any other device that connects to the computer device with data that either stores it or processes it to be used on another device. These functions (i.e., features, capabilities and/or processes) can be arranged into one or more modules. As described herein, certain of these modules are described with particular names. However, these names are provided for illustrative purposes only and are not limiting as to the capabilities or requirements of any particular module or modules or the number of modules used to provide such functions (e.g., features, functions, capabilities) because these functions can be provided in one module or any number of separate or distinct modules that may be capable of interacting with each other and/or the user.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic illustrating aspects of certain preferred embodiments of this invention that are applied to manage the contractual obligations and duties of the parties to an agreement, contract, or grant.

FIG. 2 is a schematic illustrating aspects of certain preferred embodiments of this invention that provide the user with a process that is a seamless flow from fund sources to payments, and at each step, tracking controls assure efficiency, timeliness, and accurate reporting.

FIG. 3 is a flowchart illustrating aspects of certain preferred embodiments of this invention showing process flow for purchaser/contract administrators and contractors.

### DETAILED DESCRIPTION OF THE INVENTION

Certain preferred embodiments of this invention are comprised of one or more modules that provide one or more of the functions described herein for managing one or more contracts.

In applying this invention to provide the integrated management of contracts, contract administrators engage one or more contractors via agreements to provide multiple services. The control and financial administration of a contract includes determining how the contract will be managed (selection of contract managers), the level of detail to be managed (summary to granular), and the tracking control against goals, funding sources, service categories, persons, or specific assets for whom services are rendered. Once these determinations are made on a contract, certain embodiments of this invention guide the contractor in correctly submitting contract billings. A feature of this two-sided platform is that any user may assume the role of the payer (Contract Administrator) or payee (Contractor).

Contract managers handle one or more aspects of contract management from origination to monitoring and approval depending on designation by their accounts. Certain embodiments of this invention allow the assignment of a specific managers to one or more contracts to fulfill the management process.

Goals—certain embodiments of this invention allow the tracking of contractual expenses at a detailed level. Expenditures can be mapped against specific corporate goals and objectives and this mapping further drives reporting analytics.

Funds (Funding Sources)—certain embodiments of this invention track funds to reflect the specific sources of funds for each service in a contract. This is possible over multiple years (and contract renewals) and certain embodiments of this invention have features to map accounts used in a General Ledger (external to the systems of this invention).

Programs—certain embodiments of this invention allow the tracking of services in corporate or government programs, to ensure that expenditure details can tracked at the program component level. This setup drives reporting analytics, and programs can also be related to specific program funds for further control.

Service Categories are used in certain embodiments of this invention as a taxonomy against which each service in a contract can be classified. These include the broad service categories broken down into multiple service types. This enables the aggregation of detail across multiple contracts (and even over a broad time span) to know at any point in time how much is expended in any service category.

Assets—such as autos, buildings, equipment can be tracked as consumed, or provided a service on contracts. Certain embodiments of this invention allow the users to relate their internal identification systems to identify such assets (e.g., assigning internally generated ID's).

Clients (persons)—certain embodiments allow tracking for contracted services provided to specific individuals, such as case managed services.

A Contract Summary feature of certain embodiments is a control feature that establishes the limits of a contract (e.g., valid timeframe, designated contractor, and budget) against which all details are tracked. It establishes the reporting relationship between contract administrator, contract manager and contractor, and acts as a control for the details associated with the contract (i.e., service line item and deliverables breakdowns).

Service (line items) features of certain embodiments are the breakdown of the contract into individual services that a contractor must deliver on a contract. Services can be related to specific goals, programs, assets, or persons as well as funding sources. A service can further be categorized using the service types so that tracking, control, and analytics at a detail level is possible.

Deliverables—these features of certain embodiments are subcomponents of services, that allow for a finer detail of contractor reporting. Deliverables can be expressed in terms of their units of measure (e.g., per mile, per completion, each, per day, etc.) and ensure that charges are computed according to agreed rates.

A Deliverable Schedule is maintained in these embodiments to control for allowable timeframes in which each service must be delivered. This includes a span of time or individually determined milestones in which certain contract items should be concluded and billed for.

Contract Documents—are original documents that are attached to contracts, allowing for easy reference and access whenever source documents are required.

Invitation—This feature is used by certain embodiments of this invention to manage the relationship with new contractors and is an easy way for an administrator to expand their contractor network. A contractor can be connected to multiple contract administrators at one time, and Invitations will recognize when a contractor is already registered in certain embodiments of this invention.

Notifications are messages related to transaction updates and other key events that occur in the contract management cycle. Notifications are received by email, text and via on-screen displays.

Service Authorization is a control mechanism that controls when a contractor can proceed with a specific service. A contract administrator can decide how much of a contract can be fulfilled at a time, thereby increasing the administrative capacity of a contract manager or administrator.

Invoice Documents are support documents that are submitted as evidence of completion of services. A unique feature in certain embodiments of this invention is that documents can be submitted before, during or after invoicing depending on the flexibility of the contracting entity. Certain embodiments of this invention allow for the approval of support documents independent of, or in conjunction with the approval of submitted charges.

Charges are the independent details of expenses incurred on a contract. Charges carry the rates (unit cost), dates incurred, units of measure (dollars, miles, completion, hours etc.) to ensure full accountability for the incurred expense. Charges also trackable against the targets of the service such as person, asset, goal, program, or service category, which enables granular analytics of contracts administered.

Invoices are submitted by contractors to a contracting agency for approval and are an aggregation of submitted charges in a billing period. Certain embodiments of this invention ensure no orphan charges are created and/or maintained as a contractor always has the option to include unbilled charges from prior periods to be included in an invoice. Invoices are then approved or declined at a granular level (i.e., approvals on a charge-by-charge basis) or in summary (i.e., all charges approved or declined at once) with associated supporting documentation automatically available at the time of invoice review and approval.

Contractors: also supplier, vendor, service provider—is a contracted entity engaged to provide services. The contractor can be engaged by multiple contracting entities who use embodiments of this invention without having to log in to multiple accounts or multiple systems.

Journal/Payment Systems Interface: This interface of certain embodiments (e.g., an Accounting Interface module) enables the details of contracts and approved services to be passed to the accounting or financial system for the issuance of payments and maintenance of the general ledger.

Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

As an example of embodiments of this invention, an SaaS-based product is an embodiment of this invention that is an integrated contract management system that comprises modules performed by computer executable functions that are stored on a computer device (e.g., computer desktop, remote server) that run on a computer terminal, smartphone or any other device that connects to the computer device with data that either stores it or processes it to be used on another device. Each of the modules (which can be combined into a fewer number of modules or split into a greater number of modules (i.e., the number of modules is not a set aspect of this invention and the actual number of modules used can vary according to how the features that are provided are arranged)) can interact with each other in the system of these embodiments and are also accessible by a user-interface accessible by one or more users. In the most preferred embodiments, a single user-interface is used that can have multiple screens. By a single interface, it is meant that a user does not need to access multiple program interfaces (e.g., Excel, Word) to obtain information and manage the contracts of interest.

The modules in these embodiments comprise a Fund Manager, Tracking Designations, Contract Detail, Authorization Management, Contract Receivables (Billing and Documentation), Contract Payables (Reviews and Approvals), Accounting Interface (Payment Integration) and Analytics module. These modules are capable of performing various contract management functions, including allowing for the selection of contract managers, providing the level of detail to be managed (summary to granular), and contract tracking control against goals, funding sources, service categories, persons, or specific assets for whom services are rendered. Once these determinations are made for a contract, the embodiments of this example guide the contractor or other user in correctly submitting contract billings. This example provides a two-sided platform in that any user may assume the role of the payer (Contract Administrator) or payee (Contractor).

In certain embodiments, specific contract managers are assigned by the system to handle one or more aspects of contract management from origination to monitoring and approval depending on designation by their accounts. Goals are then set in the system that allow the tracking of contractual expenses at a detailed level. Expenditures can be mapped against specific corporate goals and objectives and this mapping further drives reporting analytics.

Particular features that are provided by one or modules, or across one or more of the modules, comprise: Contractual Fund Tracking; Contractual Program Application; Contractual Categorization; Contractual Asset Tracking; Contractual Client Tracking; Contract Summary; Contractual Service Tracking; Deliverable Tracking; Deliverable Scheduling; Contract Documentation; Invitations; Notifications; Contractual Service Authorizations; Invoice Documentation; Charges; Invoice Submission; Contractor Identity; and a Journal/Payment Systems Interface, which are each described further below.

Contractual Fund Tracking (Funding Sources) tracks funds by the system to reflect the specific sources of funds for each service in a contract. This is possible over multiple years (and contract renewals) and the system is used to map accounts used in a General Ledger (external to the systems of this invention).

Contractual Program Application are applied by the system that provides for the tracking of services in corporate or government programs, to ensure that expenditure details can tracked at the program component level. This setup drives reporting analytics, and programs can also be related to specific program funds for further control.

Contractual Categorization/Service Categories are used and set by the user in the system and are used as a taxonomy against which each service in a contract can be classified. These include the broad service categories broken down into multiple service types. This enables the aggregation of detail across multiple contracts (and even over a broad time span) to know at any point in time how much is expended in any service category.

Contractual Asset Tracking where assets are inputted by the user and the system tracks such assets, such as autos, buildings, and equipment, as they are depreciated, consumed, and/or provided a service on contracts. The system is capable of allowing users to relate their internal identification systems to identify such assets (e.g., assigning internally generated ID's).

Contractual Client (persons) Tracking tracks person by the system for contracted services provided to specific individuals, such as case managed services.

A Contract Summary feature of the system is provided that is a control feature that establishes the limits of a contract (e.g., valid timeframe, designated contractor, and budget) against which all details are tracked. It establishes the reporting relationship between contract administrator, contract manager and contractor, and acts as a control for the details associated with the contract (i.e., service line item and deliverables breakdowns).

Contractual Service (line items) Tracking tracks features that are the breakdown of the contract into individual services that a contractor must deliver on a contract are input into the system and tracked. Services can be related to specific goals, programs, assets, or persons as well as funding sources. A service can further be categorized using the service types or categories so that tracking, control, and analytics at a detail level is possible.

Deleverable Tracking; deliverables are addressed and processed by the system as subcomponents of services that allow for a finer detail of contractor reporting. Deliverables can be expressed in terms of their units of measure (e.g., per mile, per completion, each, per day, etc.) and ensure that charges are computed according to agreed rates.

Deliverable Scheduling is maintained in the system to control for allowable timeframes in which each service must be delivered. This includes a span of time or individually determined milestones in which certain contract items should be concluded and billed for.

Contract Documentation are maintained and accessed by the system. These include that original documents that are attached to contracts, allowing for easy reference and access whenever source documents are required.

An Invitations feature is used by the system to manage the relationship with new contractors and is an easy way for an administrator to expand their contractor network. A contractor can be connected to multiple contract administrators at one time, and Invitations will recognize when a contractor is already registered in certain embodiments of this invention.

Notifications are a feature of the system and they are messages related to transaction updates and other key events that occur in the contract management cycle. Notifications are received by email, text and via on-screen displays.

Contractual Service Authorizations is a control mechanism used by the system that controls when a contractor can proceed with a specific service. A contract administrator can decide how much of a contract can be fulfilled at a time, thereby increasing the administrative capacity of a contract manager or administrator.

Invoice Documentation is used by the system to provide support documents that are submitted as evidence of completion of services. A unique feature of the system is that documents can be submitted before, during or after invoicing depending on the flexibility of the contracting entity. Certain embodiments of this invention allow for the approval of support documents independent of, or in conjunction with, the approval of submitted charges.

Charges are addressed and processed by the system and they are the independent details of expenses incurred on a contract. Charges carry the rates (unit cost), dates incurred, units of measure (dollars, miles, completion, hours, etc.) to ensure full accountability for the incurred expense. Charges also trackable against the targets of the service such as person, asset, goal, program, or service category, which enables granular analytics of contracts administered.

Invoice Submission is where invoices are submitted by contractors to the system for approval and are an aggregation of submitted charges in a billing period. Certain embodiments of this invention ensure no orphan charges are created and/or maintained as a contractor always has the option to include unbilled charges from prior periods to be included in an invoice. Invoices are then approved or declined by a user of the system at a granular level (i.e., approvals on a charge-by-charge basis) or in summary (i.e., all charges approved or declined at once) with associated supporting documentation automatically available at the time of invoice review and approval.

Contractor Identities are addressed by the system and they also include suppliers, vendors, and service providers, which are contracted entities engaged to provide services. The contractor can be engaged by multiple contracting entities who use embodiments of this invention without having to log in to multiple accounts or multiple systems.

Journal/Payment Systems Interface is used by the system (e.g., an Accounting Interface module) to enable the details of contracts and approved services to be passed to the accounting or financial system for the issuance of payments and maintenance of the general ledger.

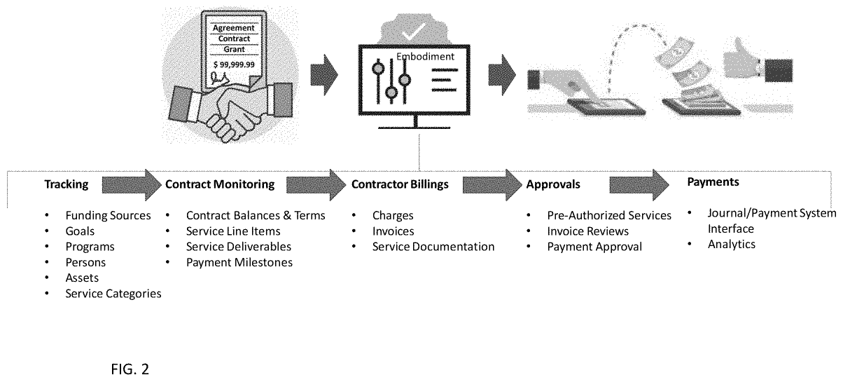

FIG. 2 illustrates certain of the components (e.g., modules), functions and benefits of embodiments of this and other examples of this invention, including tracking, contract monitoring, contractor billings, approvals or authorizations and payments.

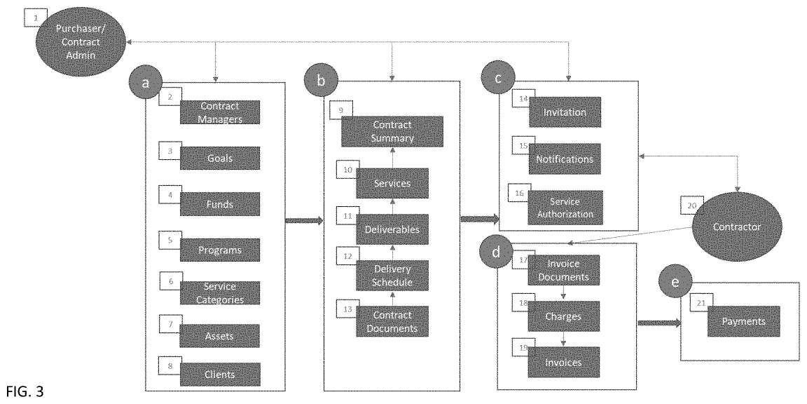

FIG. 3 also illustrates certain of the components (e.g., modules) of this and other examples of this invention and how they may be applied to interact with one another. Thus, in this example, purchaser/contract administrator 1 can provide input and obtain output from a system. In part a of the system, contract managers 2, goals 3, funds 4, programs 5, service categories 6, assets 7 and clients 8 are input and/or accessesed in the form of, for example, modules and/or functions or features.

In part b of the system, which is capable of receiving input from the purchaser/contract administrator 1 and/or part a of the system, a contract summary 9, services 10, deliverables 11, delivery schedule 12 and contract documents 13 are input and/or accessed in the form of, for example, modules and/or functions or features.

In part c of the system, which is capable of receiving input from the purchaser/contract administrator 1 and/or part b of the system, as well as a contractor 20, invitations 14, notifications 15 and service authorizations 16 are output from and/or accessed in the form of, for example, modules and/or functions or features.

In part d of the system, which can obtain input from a contractor 20 (e.g., a contractor can submit an invoice) invoice documents 17, charges 18 and invoices 19 can relate to one another as indicated and they are input and/or accessed in the form of, for example, modules and/or functions or features.

In part e of the system, which can obtain input from part d of the system, payments 21 can be output from and/or accessed in the form of, for example modules and/or functions or features.

In the most preferred embodiments of this example, an integrated system is provided for managing contracts that comprises multiple modules each performed by computer executable functions that are stored and run on one or more computer devices, wherein each of the modules can interact with one or more of each other (directly or indirectly) and are accessible by a single user-accessible interface.

In these most preferred embodiments, the modules comprise a fund manager module for managing the application and tracking of funds to a contract; a tracking designations module for tracking the progress and events associated with a contract; a contract detail module for storing the details of a contract including its terms and categorization; an authorization management module for providing for the authorization of events comprising invoice payment under a contract; a contract receivables module for billing and documentation; a contract payables module for review and approval of invoicing and payments; an accounting interface module for integration with accounting systems; and an analytics module for providing analytical tools concerning a contract.

In these most preferred embodiments, functions that are provided within one or more of the modules or between one or more of the modules comprise contractual fund tracking; contractual program application; contractual categorization; contractual asset tracking; contractual client tracking; contract summary; contractual service tracking; deliverable tracking; deliverable scheduling; contract documentation; invitations; notifications; contractual service authorizations; invoice documentation; charges; invoice submission; contractor identities; and a journal/payment systems interface.

### Example 2

In this example an integrated method is provided for a user to manage contracted goods, services, and/or expenditures pertaining to contractual terms using a single user-accessible interface accessible by one or more computer devices. The method comprises at least five steps, comprising (a) analyzing and determining the progress of the delivery of the contracted goods, services, and/or expenditures with respect to the contractual terms on the user-accessible interface; (b) submitting and tracking the invoicing of the contracted goods, services, and/or expenditures and comparing them to the contractual terms and the progress of the delivery of the contracted goods, services, and/or expenditures on the user-accessible interface; (c) authorizing the payment for the contracted goods, services, and/or expenditures on the user-accessible interface; (d) transferring payment details for the contracted goods, services, and/or expenditures to the user's accounting and/or payment system; and (e) monitoring of the contracted goods, services, and/or expenditures by recording the delivery of the contracted goods and/or services and/or payment of the expenditures on the user-accessible interface. Each of these steps (i.e., (a) through (e)) is performed on a single, integrated and synchronized system to which contract management information is input, accessed and updated in real time. In certain preferred embodiments of this method, a party to a contract who is not the user can submit invoicing and/or other documentation that is accessible to the user-accessible interface without requiring the user to submit the invoice and/or other documentation.

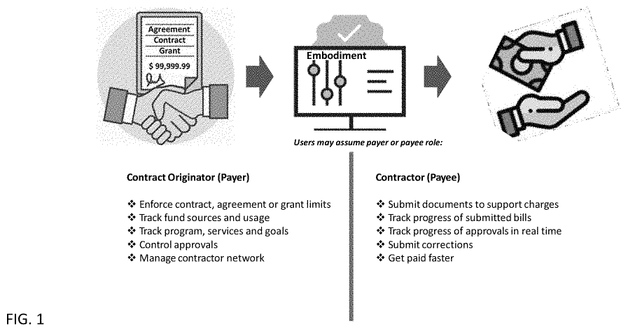

FIG. 1 illustrates embodiments of this and other examples of this invention showing potential benefits and functions of the method of embodiments of this invention to both the contract originator or payer (e.g., tracking fund sources and usage) and the contractor or payee (e.g., submitting documents to support charges).

Such an inventive method was not provided before. It is accessible to a single, user-accessible interface. The advantages of such a method are considerable, and include enhanced transparency, clarity, convenience, efficiency and accuracy, compared to methods and systems used in the past that were not integrated and required users to access several different systems stored in different places.

### Example 3

In this example an integrated system is provided for a user to manage contracted goods, services, and/or expenditures pertaining to contractual terms. The embodiments of the system of this example comprise: (a) a single user-accessible interface accessible by one or more computer devices; (b) an analysis module that evaluates the progress of the delivery of the contracted goods, services, and/or expenditures with respect to the contractual terms and provides the results of the analysis on the user-accessible interface; (c) an invoice submission and tracking module that permits the submission of invoices for contracted goods, services, and/or expenditures to the user-accessible interface if they comply with the results of the analysis module; (d) an authorizing payment module that permits the user using the user-accessible interface to approve the payment of the invoices that have been submitted that comply with the contractual terms and that have been provided by the invoice submission module; (e) a payment transfer module that transfers the details for the payment of the contracted goods, services, and/or expenditures from the authorizing payment module to the user's accounting and/or payment system; and (f) a monitoring module that provides the user with information on the delivery of and/or payment for the contracted goods and/or services and/or payment of the expenditures on the user-accessible interface. In these embodiments, the modules are synchronized and inputs and updates to the system are made in real time. Thus, if the system is interrogated for information, the information will always be current and there is no delay in making updates, which is often the case for siloed systems of the past. In certain preferred embodiments of this system, a party to a contract who is not the user can submit invoicing and/or other documentation to the invoice submission and tracking module that is accessible to the user-accessible interface without requiring the user to submit the invoice and/or other documentation.

A system such as this one was not provided before, which is accessible to a single, user-accessible interface. The advantages of such a system are considerable, and include enhanced transparency, clarity, convenience, efficiency and accuracy, all done in real time in some embodiments, compared to methods and systems used in the past that were not integrated and required users to access several different systems stored in different places.

### Example 4

In these embodiments of this invention, a system was created comprised of multiple interacting and integrated modules. These modules include modules with features and capabilites of (1) fund management (for managing the application and tracking of funds allocated to a contract), (2) contract processing (for tracking the events and progress associated with a contract), (3) service authorization (for providing for the authorization of events under a contract), (4) contractor billing (for review and approval of contractor invoicing and payments), (5) service documentation (for tracking the recording and/or tracking the services provided for under a contract), (6) management reporting (for providing reports and analytical tools concerning a contract and events and progress made under the contract), and (7) an interface to existing payment and accounting systems, such as a payment module, where final settlements are made.

The embodiments of this example, and certain other embodiments of this invention, are capable of providing for the real time (i) management of multiple contracts and their relevant detail, (ii) synchronization of inputs across the modules, (iii) checking for the accuracy of inputs and outputs, (iv) creation of audit trails for multiple contracts and each update regarding each contract, (v) consistent classification of expenses relating to the contracts across the modules (which is often required when using multiple siloed, non-integrated systems), (vi) answers to the questions of where funds are allocated and where funds are spent, and (v) supporting of cashflow forecasting by providing up-to-date information as to unbilled services and the rate of expenditures as compared to expected time-frames.

Once the contractual details were input into the system, the system synchronized all aspects of the transactions, such as the flagging of all services in the system (including notifications to providers) if a fund was modified or suspended for an already contracted service, or notifying a particular administrator whenever service documentation or invoices are submitted. Such notices are in real time; heretofore, in the past there was limited transparency between the contract administration and the contractor domains (except for billing approvals or disputes that were typically undertaken after the fact). With these embodiments, the transparency is in detail and in real time. Although certain discrete modules are identified in this example, the functions, features, and capabilities of these modules can be broken up or combined into a different number of modules.

### Example 5

In the embodiments of this example of this invention, a system for the management of multiple contracts is provided. The system comprises a single, integrated, and discrete (e.g., by discrete it is meant that it is not a collection of multiple, disconnected, siloed programs (e.g., Excel, Word, etc.) but instead is a single, integrated system that can interact with a user interface and, in some embodiments, can interface with separate accounting, payment, journal, and/or banking systems) system with multiple functions, features and capabilities relating to the management of the performance and obligations under multiple contracts. The multiple functions, features and capabilities relating to the performance and obligations under multiple contracts comprises the inputting of contractual details, service documentation, service authorizations, and contractor billing. In addition, the system is capable of providing for the real time (i) management of multiple contracts and their relevant detail, (ii) synchronization of inputs across the modules, (iii) checking for the accuracy of inputs and outputs, (iv) creation of audit trails for multiple contracts and each update regarding each contract, (v) consistent classification of expenses, (vi) answers to the questions of where funds are allocated and where funds are spent, and (v) supporting of cashflow forecasting by providing up-to-date information as to unbilled services and the rate of expenditures as compared to expected time-frames. This synchronization in real time across the system results in no delay needed by siloed systems for updating information across multiple systems and thus the ability to rely on information provided by the system concerning the contracts under management.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. An integrated method for a user to manage contracted goods, services, and/or expenditures pertaining to contractual terms using a single user-accessible interface accessible by one or more computer devices, the method comprising:
(a) analyzing and determining the progress of the delivery of the contracted goods, services, and/or expenditures with respect to the contractual terms on the user-accessible interface;
(b) submitting and tracking the invoicing of the contracted goods, services, and/or expenditures and comparing them to the contractual terms and the progress of the delivery of the contracted goods, services, and/or expenditures on the user-accessible interface;
(c) authorizing the payment for the contracted goods, services, and/or expenditures on the user-accessible interface;
(d) transferring payment details for the contracted goods, services, and/or expenditures to the user's accounting and/or payment system;
(e) monitoring of the contracted goods, services, and/or expenditures by recording the delivery of the contracted goods and/or services and/or payment of the expenditures on the user-accessible interface; and
(f) wherein (a), (b), (c), (d), and (e) are performed on a single, integrated, and synchronized system to which contract management information is input, accessed and updated in real time.

2. The integrated method of claim 1 wherein the method further comprises the submitting to the user-accessible interface of invoicing by a party to a contract who is not the user.

3. An integrated system for a user to manage contracted goods, services, and/or expenditures pertaining to contractual terms, the system comprising:
(a) a single user-accessible interface accessible by one or more computer devices;
(b) an analysis module that evaluates the progress of the delivery of the contracted goods, services, and/or expenditures with respect to the contractual terms and provides the results of the analysis on the user-accessible interface;
(c) an invoice submission and tracking module that permits the submission of invoices for contracted goods, services, and/or expenditures to the user-accessible interface if they comply with the results of the analysis module;
(d) an authorizing payment module that permits the user using the user-accessible interface to approve the payment of the invoices that have been submitted that comply with the contractual terms and that have been provided by the invoice submission module;
(e) a payment transfer module that transfers the details for the payment of the contracted goods, services, and/or expenditures from the authorizing payment module to the user's accounting and/or payment system;
(f) a monitoring module that provides the user with information on the delivery of and/or payment for the contracted goods and/or services and/or payment of the expenditures on the user-accessible interface; and
(g) wherein the modules are synchronized and inputs and updates to the system are made in real time.

4. The integrated system of claim 3 wherein the system further comprises the submitting of invoicing by a party to a contract, who is not the user, to the invoice submission and tracking module and the user-accessible interface.

5. An integrated system for the management of contracts comprising:
(a) multiple modules each performed by computer executable functions that are stored and run on one or more computer devices, wherein each of the modules can synchronize and/or interact with one or more of each other in real time and are accessible by a user-accessible interface; and
(b) the modules comprising a fund manager module for managing the application and tracking of funds to a contract; a tracking designations module for tracking the progress and events associated with a contract; a contract detail module for storing the details of a contract including its terms and categorization; an authorization management module for providing for the authorization of events comprising invoice payment under a contract; a contract receivables module for billing and documentation; a contract payables module for review and approval of invoicing and payments; and an accounting interface module for integration with accounting systems; and an analytics module for providing analytical tools concerning a contract.

6. An integrated system for the management of contracts comprising interacting and integrated modules, the modules comprising:
(a) a fund management module providing for managing the application and tracking of funds allocated to a contract;
(b) a contract processing module providing for tracking the progress and events associated with a contract;
(c) a service authorization module providing for the authorization of events under a contract;
(d) a contractor billing module providing for review and approval of contractor invoicing and payments;
(e) a service documentation module providing for recording and/or tracking the services provided for under a contract;
(f) a management reporting module providing for providing reports and analytical tools concerning a contract and events and progress made under the contract;
(g) a payment module comprising an interface to existing payment and accounting systems; and
(h) wherein the integrated system is capable of providing for the real time (i) management of multiple contracts and their relevant detail, (ii) synchronization of inputs across the modules, (iii) checking for the accuracy of inputs and outputs across the modules, (iv) creation of audit trails for multiple contracts and each update regarding each contract, (v) consistent classification of expenses across the modules, (vi) answers to the questions of where funds are allocated and where funds are spent, and (v) supporting of cashflow forecasting by providing up-to-date information as to unbilled services and the rate of expenditures as compared to expected time-frames.

7. A system for the management of multiple contracts, the system comprising:
(a) a single, integrated, and discrete system with multiple functions, features and capabilities relating to the management of the performance and obligations under multiple contracts;
(b) wherein the multiple functions, features and capabilities relating to the performance and obligations under multiple contracts comprises the inputting of contractual details, service documentation, service authorizations, and contractor billing; and
(c) wherein the integrated system is capable of providing for the real time (i) management of multiple contracts and their relevant detail, (ii) synchronization of inputs across the modules, (iii) checking for the accuracy of inputs and outputs, (iv) creation of audit trails for multiple contracts and each update regarding each contract, (v) consistent classification of expenses, (vi) answers to the questions of where funds are allocated and where funds are spent, and (v) supporting of cashflow forecasting by providing up-to-date information as to unbilled services and the rate of expenditures as compared to expected time-frames.
